(19) United States
(12) Patent Application Publication
(10) Pub. No.: US 2008/0171649 A1
(43) Pub. Date: Jul. 17, 2008

(54) Modified Y-85 and LZ-210 Zeolites

(76) Inventors: Deng-Yang Jan, Elk Grove Villiage, IL (US); Robert J. Schmidt, Barrington, IL (US); Mathias P. Koljack, Gilberts, IL (US); Thomas M. Reynolds, Mobile, AL (US); Christopher J. Garrett, Mobile, AL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/622,896

(22) Filed: Jan. 12, 2007

(51) Int. Cl. B01J 29/06

(52) U.S. Cl. 502/64

(57) ABSTRACT

Catalysts for converting polyalkylaiomatics to monoalkylaromatics, particularly cumene and ethyl benzene are disclosed which comprise modified Y-85 or LZ-210 zeolites. For cumene and ethylbenzene production, a disclosed catalyst, made of 80 wt % zeolite and 20 wt % alumina binder on a volatile-flee basis, has one or more of the following physical characteristics: (1) an absolute intensity of the modified Y zeolite as measured by X-ray diffraction (XRD) of preferably at least 50 and (2) a framework aluminum of the modified Y zeolite of preferably at least 50% of the aluminum of the modified Y zeolite.

### TECHNICAL FIELD

Modified Y-85 and LZ-210 zeolites are disclosed herein along with methods of manufacture thereof that can be used as catalysts in the transalkylation of polyalkylaromatics, e. g PIPBs and PEBs, into cumene and ethyl benzene.

### BACKGROUND

The following description will make specific reference to the use of catalysts disclosed herein in the transalkylation of polyisopropylbenzenes (PIPBs) with benzene to afford cumene, but it is to be recognized that this is done solely for the purpose of clarity and simplicity of exposition Frequent reference will be made herein to the broader scope of this application for emphasis.

Cumene is a major article of commerce, with one of its principal uses being a source of phenol and acetone via its air oxidation and a subsequent acid-catalyzed decomposition of the intermediate hydroperoxide.

Because of the importance of both phenol and acetone as commodity chemicals, there has been much emphasis on the preparation of cumene and the literature is replete with processes for its manufacture The most common and perhaps the most direct method of preparing cumene is the alkylation of benzene with propylene, especially using an acid catalyst.

Another common method of preparing cumene is the transalkylation of benzene with PIPB, particularly di-isopropylbenzene (DIPB) and tri-isopropylbenzene (TIPB), especially using an acid catalyst Any commercially feasible transalkylation process must satisfy the requirements of a high conversion of polyalkylated aromatics and a high selectivity to monoalkylated products.

The predominant orientation of the reaction of benzene with PIPB resulting in cumene corresponds to Markownikoff addition of the propyl group However, a small but very significant amount of the reaction occurs via anti-Markownikoff addition to afford n-piopylbenzene (NPB). The significance of NPB formation is that it interferes with the oxidation of cumene to phenol and acetone, and consequently cumene used for oxidation must be quite pure with respect to NPB content.

Because cumene and NPB are difficult to separate by conventional means (e g distillation), the production of cumene via the transalkylation of benzene with PIPB must be carried out with a minimal amount of NPB production One important factor to take into consideration is that the use of an acid catalyst for the transalkylation results in increased NPB formation with increasing temperature. Thus, to minimize NPB formation, the transalkylation should be carried out at as low a temperature as possible.

Since DIPB and TIPB ate not only the common feeds for the transalkylation of benzene with PIPBs but also the common byproducts of the alkylation of benzene with propylene when forming cumene, transalkylation is commonly practiced in combination with alkylation to minimize the production of less valuable byproducts and to produce additional cumene. In such a combination process, the cumene produced by both alkylation and transalkylation is typically recovered in a single product stream Since NPB is also formed in alkylation and the amount of NPB formation in alkylation increases with increasing temperature, the NPB production in both alkylation and transalkylation must be managed relative to one another so that the cumene product stream is relatively free of NPB.

What is needed is an optimum transalkylation catalyst for, e.g., cumene or ethyl benzene production, with sufficient activity to effect transalkylation at acceptable reaction rates at temperatures sufficiently low to avoid unacceptable NPB formation. Because Y zeolites show substantially greater activity than many other zeolites, they have been received close scrutiny as a catalyst in aromatic transalkylation. However, a problem exists in that Y zeolites effect transalkylation at unacceptably low lates at the low temperatures desired to minimize NPB formation.

Therefore, in order for a commercial process based on Y zeolites to become a reality, it is necessary to increase catalyst activity—i.e , increase the late of cumene or ethyl benzene production at a given, lower temperature.

### BRIEF SUMMARY OF THE DISCLOSURE

In satisfaction of the aforenoted need, catalysts ale disclosed that comprise a modified Y zeolite and having less than about 0.2 wt % of a metal hydrogenation component.

One modified Y zeolite is prepared by first ammonium ion-exchanging sodium Y zeolite to produce a low-sodium Y zeolite containing sodium cations, having a sodium content of less than about 3 wt % NaO₂ based on the weight of the low-sodium Y zeolite, on a water-free basis, and having a first unit cell size. Next, the low-sodium Y zeolite is hydrothermally steamed at a temperature ranging from about 550° C. (1022° F.) to about 850° C. (1562° F.) to produce a steamed Y zeolite containing sodium cations, having a first bulk Si/Al₂ molar ratio, and having a second unit cell size less than the first unit cell size. Finally, the steamed Y zeolite is contacted with a sufficient amount of an aqueous solution of ammonium ions and having a pH of less than about 4, preferably ranging from about 2 to about 4, for a sufficient time to exchange at least some of the sodium cations in the steamed Y zeolite for ammonium ions and to produce the modified Y zeolite having a second bulk Si/Al₂ molar ratio greater than the first bulk Si/Al₂ molar ratio and, preferably, in the range of from about 6.5 to about 27. The unit cell size of the modified Y zeolite is in the range of 24.34 to 24.58 Å.

Another modified Y zeolite is prepared be treating a starting material, such as a Y-54 zeolite, with aqueous fluorosilicate solution resulting in a LZ-210 zeolite having a first unit cell size Thereafter, the fluorosilicate-treated samples are subjected to steaming at temperatures ranging from about 550° C. (1022° F.) to about 850° C. (1562° F.) to produce a steamed LZ-210 zeolite containing sodium cations, having a first bulk Si/Al₂ molar ratio, and having a second unit cell size less than the first unit cell size Finally, the steamed LZ-210 zeolite is contacted with a sufficient amount of an aqueous solution of ammonium ions and having a pH of less than about 4 for a sufficient time to exchange at least some of the sodium cations in the steamed LZ-210 zeolite for ammonium ions and to produce the modified LZ-210 zeolite having a second bulk Si/Al₂ molar ratio greater than the first bulk Si/Al₂ molar ratio and in the range of from about 6.5 to about 27. The unit cell size of the modified Y zeolite is in the range of from about 24.34 to about 24.58 Å. Then, an acid extraction can be performed to remove the extra-framework aluminum Before the Y zeolite is treated with fluorosilicate salt or after, or both, the catalyst may be subject to an ammonium ion exchange(s) to reduce the sodium content of the catalyst to a Na₂O wt % of 1 wt % or lower while maintaining the first hulk Si/Al₂ molar ratio In another embodiment, fluorosilicate treated Y zeolite (or LZ-210 zeolite) can be ammonium exchanged, without going through the steaming step, to lower Na₂O contents further to produce a material suitable for this disclosure.

The disclosed manufacturing techniques affect the number and nature of extra-framework aluminum (and Lewis acid sites), as shown by a changed Si/Al₂ ratio and a changed unit cell size thereby improving diffusion characteristics, increasing catalyst activity, and lowering the NPB formation.

One disclosed catalyst comprises zeolite and binder and has at least one characteristic selected from the group consisting of: (1) an absolute intensity of the modified Y zeolite as measured by X-ray diffraction (XRD) of at least 50; and (2) a framework aluminum of the modified Y zeolite of preferably at least 50%

In one example, the finished catalyst for cumene production has a product of the absolute intensity of the modified Y zeolite as measured by XRD and the % framework aluminum of the aluminum in the modified Y zeolite that is greater than 4200.

In another example, a catalyst for ethyl benzend production has a product of the absolute intensity of the modified Y zeolite as measured by XRD and the % framework aluminum of the aluminum in the modified Y zeolite that is greater than 4500.

Other embodiments of the process disclosed herein are described in the detailed description.

### BRIEF DESCRIPTION OF THE DRAWINGS

FIG. 1 illustrates, graphically, DIPB conversion (y-axis, %) versus temperature (x-axis, ° C.) for catalysts prepared in accordance with Examples 2-4 and 7 of this disclosure against Comparative Examples 1 and 5;

FIG. 2 illustrates, graphically, a ratio of NPB to cumene (y-axis, wt-ppm) in the product versus DIPB conversion (x-axis, %) for the catalysts of Examples 2-4 and 7 of this disclosure and against Comparative Examples 1 and 5;

FIG. 3 illustrates, graphically, DIPB conversion (y-axis, %) versus temperature (x-axis, ° C.) for the catalyst of Example 3 before regeneration (Example 7) and after regeneration (Example 9) and against Comparative Example 1;

FIG. 4 illustrates, graphically, the ratio of NPB to cumene (y-axis, wt-ppm) in the product versus DIPB conversion (x-axis, %) fbr the catalyst of Example 3 before regeneration (Example 7) and after regeneration (Example 9) and against Comparative Example 1; and

FIG. 5 illustrates, graphically, DEB conversion (y-axis, %) versus temperature (x-axis, ° C.) for the catalyst of Example 2 of this disclosure thereby establishing that the disclosed catalysts perform well with alkyl groups other than propyl and against the Comparative Example 1.

FIG. 6 illustrates, graphically, DIPB conversion (y-axis, %) versus temperature (x-axis, ° C.) for catalysts prepared in accordance with Examples 14-16 of this disclosure against Comparative Example 11;

FIG. 7 illustrates, graphically, the ratio of NPB to cumene (y-axis, wt-ppm) in the product versus DIPB conversion (x-axis, %) for the catalysts of Examples 14-16 of this disclosure and against Comparative Example 11;

FIG. 8 illustrates, graphically, DIPB conversion (y-axis, %) versus temperature (x-axis, ° C.) for the catalyst of Example 14 before regeneration and after regeneration (Example 9) and against Comparative Example 11; and

FIG. 9 illustrates, graphically, the ratio of NPB to cumene (y-axis, wt-ppm) in the product versus DIPB conversion (x-axis, %) for the catalyst of Example 14 before regeneration and after regeneration (Example 19) and against Comparative Example 11

### DETAILED DESCRIPTION OF THE INVENTION

Improved catalysts that comprise a crystalline zeolitic molecular sieve are disclosed The molecular sieves fox use in the catalyst disclosed herein are modified Y zeolites (Y-85 zeolites) and LZ-210 zeolites

### Y-85 Zeolites

Referring to first to the Y zeolites of this disclosure, U.S. Pat. No. 3,130,007, which is hereby incorporated herein by reference in its entirety, describes Y-type zeolites The modified Y zeolites suitable for use in preparing the catalyst disclosed herein are generally derived from Y zeolites by treatment which results in a significant modification of the Y zeolite framework structure and composition, usually an increase in the bulk Si/Al₂ mole ratio to a value typically above 6.5 and/or a reduction in the unit cell size. It will be understood, however, that, in converting a Y zeolite starting material to a modified Y zeolite useful in the process disclosed herein, the resulting modified Y zeolite may not have exactly the same X-ray powder diffraction pattern for Y zeolites as described in the '007 patent. The modified Y zeolite may have an X-ray powder diffraction pattern similar to that of the '007 patent but with the d-spacings shifted somewhat due, as those skilled in the art will realize, to cation exchanges, calcinations, etc., which are generally necessary to convert the Y zeolite into a catalytically active and stable form.

The modified Y zeolites disclosed herein have a unit cell size of from about 24.34 to about 24.58 Å, preferably from about 24.36 to about 24.55 Å. The modified Y zeolites have a bulk Si/Al₂ molar ratio of from about 6.5 to about 23.

In preparing a modified Y zeolite component of the disclosed catalysts, the starting material may be a Y zeolite in alkali metal (e g, sodium) form such as described in the '007 patent. The alkali metal form Y zeolite is ion-exchanged with ammonium ions, or ammonium ion precutsors such as quaternary ammonium or other nitrogen-containing organic cations, to reduce the alkali metal content to less than about 4 wt %, preferably less than about 3 wt %, more preferably less than about 2.5 wt %, expressed as the alkali metal oxide (e.g Na₂O) on a dry basis. As used herein, the weight of the zeolite on a water-free or dry basis means the weight of the zeolite after maintaining the zeolite at a temperature of about 900° C. (1652° F.) for roughly 2 hours.

Optionally, the starting zeolite can also contain or at some stage of the modification procedure be ion-exchanged to contain rare earth cations to the degree that the rare earth content as RE₂O₃ constitutes from about 0.1 to about 12.5 wt % of the zeolite (anhydrous basis), preferably from about 8.5 to about 12 wt %. It will be understood by those skilled in the art that the ion-exchange capacity of the zeolite for introducing rare earth cations decreases during the course of the disclosed treatment process. Accordingly, if rare earth cation exchange is carried out, for example, as the final step of the preparative process, it may not be possible to introduce even the preferred amount of rare earth cations. The framework Si/Al₂ ratio of the starting Y zeolite can be within the range of less than about three 3 to about 6, but is advantageously greater than about 4.8.

The manner of carrying out this first ammonium ion exchange is not a critical factor and can be accomplished by means known in the art for example, such conventional ammonium ion exchanges are carried out at pH values above 4. It is advantageous to use a three-stage procedure with a 15 wt % aqueous ammonium nitrate solution in proportions such that in each stage the initial weight ratio of ammonium salt to zeolite is about 1. Contact time between the zeolite and the exchange medium is about 1 hr for each stage and the temperature is about 85° C. (185° F.). The zeolite is washed between stages with about 7.51 (˜2 gal) of water per 0.45 kg (˜1 lb) of zeolite The exchanged zeolite is subsequently dried at 100° C. (212° F.) to a loss on ignition (LOI) at 1000° C. of about 20 wt % If rare earth cations are used, it is preferred to contact the already ammonium exchanged form of the zeolite with an aqueous solution of rare earth salts in the known manner. A mixed rare earth chloride salt can be added to an aqueous slurry of the ammonium exchanged Y zeolite (0.386 g RECl₃ per gram of zeolite) at a temperature ranges from about 85 to about 95° C. to yield a zeolite product having a rare earth content generally in the range of from about 8.5 to 12 wt % rare earth as RE₂O₃.

After the ammonium ion exchange is completed, the steaming of the ammonium-exchanged and optionally rare earth, exchanged Y zeolite is accomplished by contact with a steam environment containing at least about 2 psia steam, and preferably 100% steam at a temperature of from about 550 to about 850° C. (˜1022 to ˜1562° F.), or from about 600 to about 750° C. (˜1112 to ˜1382° F.), for a period of time sufficient to reduce the unit cell size to less than about 24.60 Å, preferably to the range of from about 24.34 to about 24 58 Å. Steam at a concentration of 100% and a temperature ranging from about 600 to about 725° C. (˜1112 to ˜1337° F.) for about 1 hour can be used. It should be noted that the steaming step is not required for starting Y zeolite with Si/Al₂ ratios of 6.5 or higher as exemplified by fluorosilicate-treated materials, since higher Si/Al₂ ratios impart sufficient stability to survive subsequent acid extraction treatment and catalyst preparation and hydrocarbon conversion processes.

The low pH, ammonium ion exchange is a critical aspect of preparing the modified Y zeolite constituent of the catalyst used in the process disclosed herein This exchange can be carried out in the same manner as in the case of the initial ammonium exchange except that the pH of the exchange medium is lowered to below about 4, preferably to below about 3, at least during some portion of the ion-exchange procedure. The lowering of the pH is readily accomplished by the addition of an appropriate mineral or organic acid to the ammonium ion solution. Nitric acid is especially suitable for this purpose. Preferably, acids which form insoluble aluminum salts are avoided. In performing the low pH ammonium ion exchange, both the pH of the exchange medium, the quantity of exchange medium relative to the zeolite and the time of contact of the zeolite with the exchange medium are significant factors. It is found that so long as the exchange medium is at a pH below 4, sodium cations are exchanged for hydrogen cations in the zeolite and, in addition, at least some aluminum, predominately non-framework and some framework, is extracted. The efficiency of the process is improved, however, by acidifying the ion exchange medium using more acid than is required to lower the pH to just below 4 As will be evident from the data set forth below, the more acidic the exchange medium is, the greater the tendency to extract framework as well as non-framework aluminum from the zeolite. The extraction procedure is carried out to a degree sufficient to produce a zeolite product having a bulk Si/Al₂ ratio of from about 6.5 to about 27. In other embodiments, the bulk Si/Al₂ ratio is from about 6.5 to about 23 or more preferably from about 6.5 to about 20.

A typical Y zeolite having an overall silica-to-alumina Y-modified Y zeolite used in the catalyst of the process disclosed herein contains a Y zeolite designated Y-85. U.S. Pat. Nos. 5,013,699 and 5,207,892, incorporated herein by reference, describe Y-85 zeolite and its preparation, therefore it is not necessary herein to describe these in detail.

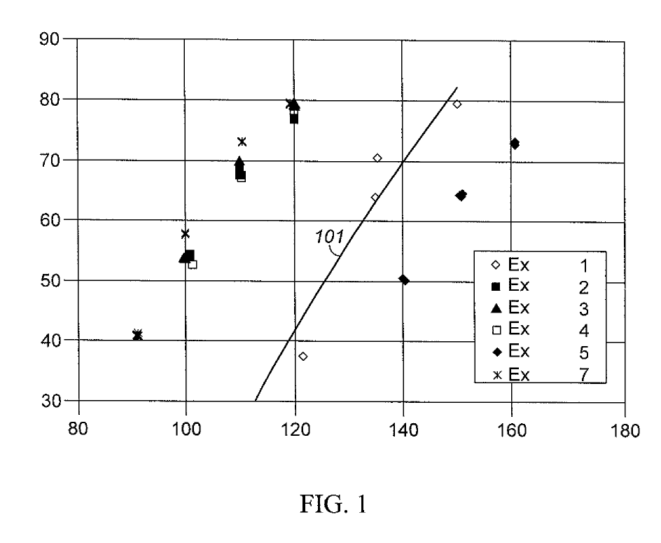

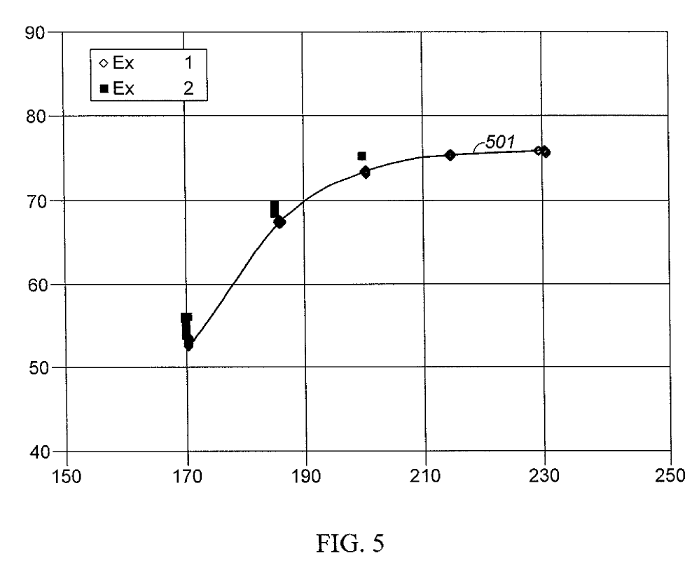

As illustrated in FIGS. 1-4 and the examples below, the disclosed catalysts provide increase catalyst activity and, in the case of cumene production, lower NPB formation. In the case of ethylbenzene production from poly-ethylbenzenes (FIG. 5), while internal isomerization of ethyl groups is of little concern and even though an ethyl group is smaller than a propyl group, the diffusion characteristics of the disclosed catalysts appear to be important.

The following examples are presented for purposes of illustration only and are not intended to limit the scope of this disclosure

### EXAMPLE 1

### Comparative

A sample of Y-74 zeolite was slurried in a 15 wt % NH₄NO₃ aqueous solution and the solution temperature was brought up to 75° C. (167° F.) Y-74 zeolite is a stabilized sodium Y zeolite with a bulk Si/Al₂ ratio of approximately 5.2, a unit cell size of approximately 24.53, and a sodium content of approximately 2.7 wt % calculated as Na₂O on a dry basis. Y-74 zeolite is prepared from a sodium Y zeolite with a bulk Si/Al₂ ratio of approximately 4.9, a unit cell size of approximately 24.67, and a sodium content of approximately 9.4 wt % calculated as Na₂O on a dry basis that is ammonium exchanged to remove approximately 75% of the Na and then steam de-aluminated at approximately 600° C. (1112° F.) by generally following steps (1) and (2) of the procedure described in col. 4, line 47 to col 5, line 2 of U.S. Pat. No. 5,324,877 Y-74 zeolite is produced and was obtained from UTOP LLC, Des Plaines, Ill. USA After 1 hour of contact at 75° C. (167° F.), the slurry was filtered and the filter cake was washed with an excessive amount of warm de-ionized water. These NH₄⁺ ion exchange, filtering, and water wash steps were repeated two more times, and the resulting filter cake had a bulk Si/Al₂ ratio of 5.2, a sodium content of 0.13 wt % calculated as Na₂O on a dry basis, a unit cell size of the 24.572 Å and an absolute intensity of 96 as determined X-ray diffraction The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1.59 mm ( 1/16 in) diameter cylindrical extrudate The extrudate was dried and calcined at approximately 600° C. (1112° F.) for one hour in flowing air. This catalyst was representative of the existing art. This catalyst had a unit cell size of 24.494 Å, an XRD absolute intensity of 61.1, and 57.2% framework aluminum as a percentage of the aluminum in the modified Y zeolite

### EXAMPLE 2

Another sample of the Y-74 zeolite used in Example 1 was slurried in a 15 wt % NH₄NO₃ aqueous solution. The pH of the slurry was lowered from 4 to 2 by adding a sufficient quantity of a solution of 17 wt % HNO₃. Thereafter the slurry temperature was heated up to 75° C. (167° F.) and maintained for 1 hour. After 1 hour of contact at 75° C. (167° F.), the slurry was filtered and the filter cake was washed with an excessive amount of warm de-ionized water. These acid extraction in the presence of NH₄⁺ ion exchange, filtering, and water wash steps were repeated one time, and the resulting filter cake had a bulk Si/Al₂ ratio of 11.5, a sodium content of less than 0.01 wt % determined as Na₂O on a dry basis, and a unit cell size of 24.47 Å. The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1 59 mm ( 1/16 in) diameter cylindrical extrudate. The extrudate was dried and calcined at approximately 600° C. (1112° F.) for one hour in flowing air. Properties of the catalyst were 68.2 wt % SiO₂ on a bulk and dry basis, 30.5 wt % Al₂O₃ on a dry basis, 0 04 wt % sodium calculated as Na₂O on a dry basis, 0 03 wt % (NH₄)₂O on a dry basis, a unit cell size of 24.456 Å, an absolute XRD intensity of 66 5, 92.2% framework aluminum as a percentage of the aluminum in the modified Y zeolite and a BET surface area of 708 m²/g.

### EXAMPLE 3

Another sample of the Y-74 zeolite used in Example 1 was slurried in a 15 wt % NH₄NO₃ aqueous solution. A sufficient quantity of a 17 wt % HNO₃ solution was added over a period of 30 minutes to remove part of extra-framewoik aluminum. Thereafter the slurry temperature was heated up to 79° C. (175° F.) and maintained for 90 minutes. After 90 minutes of contact at 79° C. (175° F.), the slurry was filtered and the filter cake was washed with a 22% ammonium nitrate solution followed by a water wash with an excessive amount of warm de-ionized water. Unlike example 2, the acid extraction in the presence of ammonium nitrate was not repeated for the second time. The resulting filter cake had a bulk Si/Al₂ ratio of 8.52, a sodium content of 0.18 wt % determined as Na₂O on a dry basis. The resulting filter cake was dried, mixed with HNO₃-peptized Putal SB alumina, extruded, dried, and calcined in the manner described for Example 2. Properties of the catalyst were a unit cell size of 24.486 Å, an absolute XRD intensity of 65.8, 81 1% framework aluminum as a percentage of the aluminum in the modified Y zeolite and a BET surface area of 698 m²/g.

### EXAMPLE 4

The same procedure described in Example 3 was followed in Example 4 with the exception that in comparison with Example 3, an increase of 33% HNO₃ was used. The same stabilized Y-74 used in Example 1 was slurried in a 15 wt % NH₄NO₃ aqueous solution. A sufficient quantity of 17 wt % HNO₃ was added to over a period of 30 minutes to remove extra-framework aluminum. Thereafter the slurry temperature was heated up to 79° C. (175° F.) and maintained for 90 minutes. After 90 minutes of contact at 79° C. (175° F.), the slurry was filtered and the filter cake was washed with an excessive amount of warm de-ionized water. These NH₄⁺ ion exchange, filtering, and water wash steps were not repeated, unlike Example 2. The resulting filter cake had a bulk Si/Al₂ ratio of 10.10, a sodium content of 0.16 wt % determined as Na₂O on a dry basis. The resulting filter cake was dried, mixed with HNO₃-peptized Pural SB alumina, extruded, dried, and calcined in the manner described for Example 2. Properties of the catalyst were a unit cell size of 24.434 Å, an absolute XRD intensity of 53.6, 74 9% framework aluminum as a percentage of the aluminum in the modified Y zeolite and a BET surface area of 732 m²/g.

### EXAMPLE 5

### Comparative

The same procedure described in Example 3 was followed in Example 5 with the exception that in comparison with Example 3, an increase of 52% HNO₃ was used. The same stabilized Y-74 used in Example 1 was slurried in a 15 wt % NH₄NO₃ aqueous solution. A sufficient quantity of a solution 17 wt % HNO₃ was added over a period of 30 minutes to increase the bulk Si/Al₂ ratio. Thereafter the slurry temperature was heated up to 79° C. (175° F.) and maintained for 90 minutes. After 90 minutes of contact at 79° C. (175° F.), the slurry was filtered and the filter cake was washed with an excessive amount of warm de-ionized water. Unlike Example 2, these NH₄⁺ ion exchange, filtering, and water wash steps were not repeated. The resulting filter cake had a bulk Si/Al₂ ratio of 11.15, a sodium content of 0.08 wt % determined as Na₂O on a dry basis. The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1.59 mm ( 1/16 in) diameter cylindrical extrudate. The extrudate was dried and calcined at approximately 600° C. (1112° F.) for one hour in flowing air. Properties of the catalyst were a unit cell size of 24.418 Å, an absolute XRD intensity of 44.8, 75.2% framework aluminum as a percentage of the aluminum in the modified Y zeolite and a BET surface area of 756 m²/g.

### EXAMPLE 6

The same stabilized Y-74 used in Example 1 was slurried in a 15 wt % NH₄NO₃ aqueous solution. The total amount of HNO₃ used in this example is the same as that in Example 5. However, instead of performing the acid extraction in a single step as described in Example 5, the acid extraction was performed in two steps with 85% of total HNO₃ acid used in the first step and the remaining 15% of the total acid used in the second step. The acid extraction piocedure/condition in each of the two individual steps was the same as that described in Example 5. A solution of 17wt-% HNO₃ was added to the slurry made up of Y-74 and NH₄NO₃ solution. Thereafter the slurry temperature was heated up to 79° C. (175° F.) and maintained for 90 minutes After 90 minutes of contact at 79° C. (175° F.), the slurry was filtered and the filter cake was washed with an excessive amount of warm de-ionized water. The acid extraction (with the remaining 15% of total HNO₃ used) in the presence of NH₄⁺, filtering, and water wash steps were repeated, and the resulting filter cake had a bulk Si/Al₂ ratio of 11.14, a sodium content of 0.09 wt % determined as Na₂O on a dry basis The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1.59 mm ( 1/16 in) diameter cylindrical extrudate. The extrudate was dried and calcined at approximately 600° C. (1112° F.) for one hour in flowing air Properties of the catalyst were a unit cell size of 24.411 Å, an absolute XRD intensity of 56.1, 72.5% framework aluminum as a percentage of the aluminum in the modified Y zeolite and a BET surface area of 763 m²/g.

### EXAMPLE 7

The same stabilized Y-74 used in Example 3 was slurried in an 18 wt % anummonium sulfate solution. To this solution a 17% sulfuric acid solution was added over 30 minutes. The batch was then heated to 79° C. (175° F.) and held for 90 minutes. The heat was removed and the batch was then quenched with process water lowering the temperature to 62° C. (143° F.) and filtered. The Y zeolite material was then re-slurried in a 6.4 wt % ammonium sulfate solution and held at 79° C. (175° F.) for one hour. The material was then filtered and water washed. The resulting filter cake had a bulk Si/Al₂ ratio of 7.71, a sodium content of 0.16 wt % determined as Na₂O on a dry basis. The resulting filter cake was dried, mixed with NO₃-peptized Pural SB alumina, extruded, dried, and calcined in the manner described for Example 2. Properties of the catalyst were a unit cell size of 24.489 Å, an absolute XRD intensity of 65.3, and 75.7% framework aluminum as a percentage of the aluminum in the modified Y zeolite.

Table 1 summarizes the properties of the catalysts prepared in Examples 1-7.

TABLE 1

| | Example | | | | | | |
|---|---|---|---|---|---|---|---|
| | 1 | 2 | 3 | 4 | 5 | 6 | 7 |
| | Type of Example | | | | | | |
| | Comparative | Example | Example | Example | Example | Example | Example |
| Figures w Run Data | 1–5 | 1–2, 5 | 1–2 | 1–2 | 1–2 | None | 1–4 |
| Y zeolite bulk Si/Al₂ | 5.20 | 11.50 | 8.52 | 10.10 | 11.15 | 11.14 | 7.71 |
| ratio, molar | | | | | | | |
| Y zeolite unit cell size, Å | 24.494 | 24.456 | 24.486 | 24.434 | 24.418 | 24.411 | 24.489 |
| Catalyst XRD absolute | 61.1 | 66.5 | 65.8 | 53.6 | 44.8 | 56.1 | 65.3 |
| intensity | | | | | | | |
| Y zeolite XRD absolute | 76.4 | 83.1 | 82.3 | 67 | 56 | 70.1 | 81.6 |
| intensity | | | | | | | |
| Y zeolite framework | 57.2 | 92.2 | 81.1 | 74.9 | 75.2 | 72.5 | 75.7 |
| aluminum, atomic % of | | | | | | | |
| total aluminum | | | | | | | |
| Catalyst BET surface | — | 708 | 698 | 732 | 756 | 763 | — |
| area, m²/g | | | | | | | |

### EXAMPLE 8

The catalysts prepared in the Examples 1-5 and 7 were tested for transalkylation performance using a feed containing benzene and polyalkylated benzenes The feed was prepared by blending polyalkylated benzenes obtained from a commercial transalkylation unit with benzene. The feed composition as measured by gas chromatography is summarized in Table 2. The test was done in a fixed bed reactor in a once-through mode under conditions of 3447 kPa(g) (500 psi(g)) reactor pressure, a molar ratio of aromatic ring groups to propyl group of 2.3, and a 0.8 hr⁻¹ DIPB WHSV over a range of reaction temperatures. The reactor was allowed to achieve essentially steady-state conditions at each reaction temperature, and the product was sampled for analysis. Essentially no catalyst deactivation occurred during the test. Prior to introducing the feed, each catalyst was subjected to a drying procedure by contacting with a flowing nitrogen stream containing less than 10 wt-ppm water at 250° C. (482° F.) for 6 hours

TABLE 2

| Component | Concentration, wt % |
|---|---|
| Benzene | 63.832 |
| Nonaromatics | 0.038 |
| Toluene | 0.002 |
| Ethylbenzene | 0.000 |
| Cumene | 0.880 |
| NPB | 0.002 |
| Butylbenzene | 0.071 |
| Pentylbenzene | 0.021 |
| m-DIPB | 20.776 |
| o-DIPB | 0.520 |
| p-DIPB | 13.472 |
| Hexylbenzene | 0.308 |
| 1,3,5-TIPB | 0.029 |
| 1,2,4-TIPB | 0.012 |
| Tetra-isopropylbenzene | 0.003 |
| Nonylbenzene | 0.004 |
| Unknowns | 0.030 |
| Total | 100.000 |

These examples show the benefits of high activity and product purity in transalkylation poly-alkylates to cumene attributed to catalysts prepared by the process disclosed herein

### EXAMPLE 9

### Regeneration

A sample of the catalyst prepared in Example 7 was tested in the manner described in Example 8, as described previously. After testing, the spent catalyst was placed in a ceramic dish, which was placed in a muffle furnace. While flowing air was passed through the muffle furnace, the furnace temperature was raised from 70° C. (158°F.) to 550° C. (1022° F.) at a rate of 1° C. (1.8° F.) per minute, held at 550° C. (1022° F.) for 6 hours, and then cooled to 110° C. (230° F.). Following regeneration, the catalyst was again tested in the manner described in Example 8.

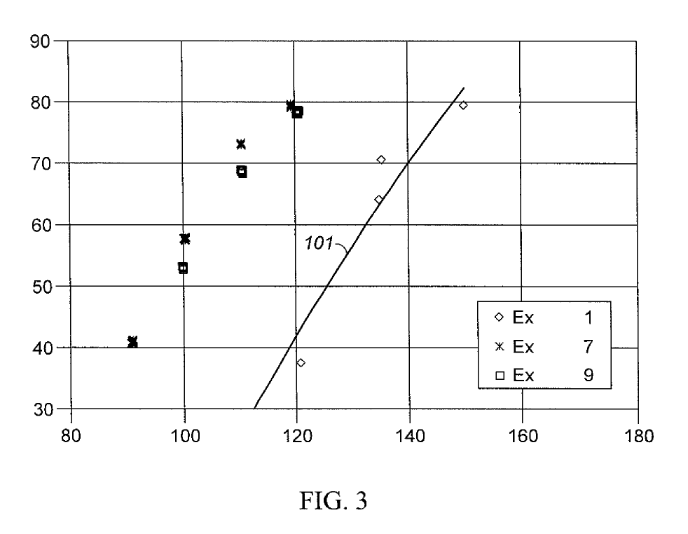

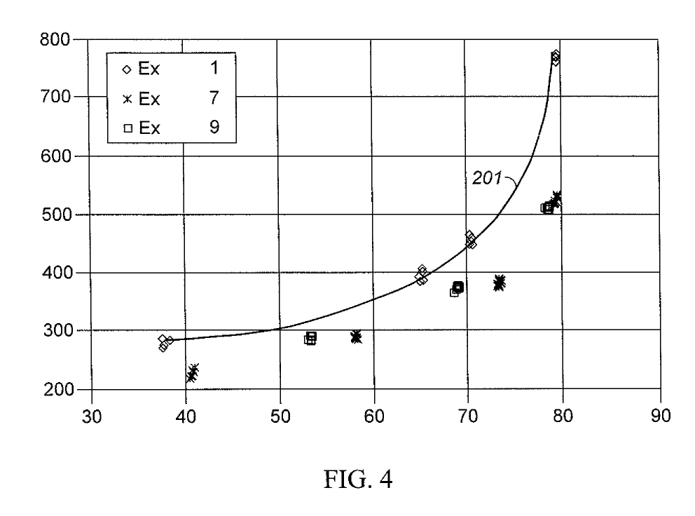

FIGS. 3 and 4 show the test results for the catalysts before regeneration (labeled “Example 7”) and after regeneration (labeled “Example 9”) The results indicate that the catalysts before and after regeneration had similar activities and product purities that were both better than the curve for the Example 1 catalyst, and therefore indicate good catalyst regenerability

### EXAMPLE 10

Samples of the catalysts prepared in Examples 1 and 2 were evaluated for transalkylation of poly-ethylbenzene. Each catalyst was tested using a feed consisting of a blend of 63.6 wt % benzene and 36.4 wt % of para-diethylbenzene (p-DEB). The catalyst was loaded into a reactor and then the catalyst was dried by contacting with a flowing nitrogen stream containing less than 10 wt-ppm of water at 250° C. (482° F.) for 6 hours. Each test was conducted at a p-DEB WHSV of 2 hr⁻¹ and over a range of reaction temperatures from 170° C. (338° F.) to 230° C. (446° F.). The reactor was allowed to achieve essentially steady-state conditions at each reaction temperature, and the product was sampled for analysis. Essentially no catalyst deactivation occurred during the test. FIG. 5 presents the results for both catalysts The results indicate that the catalyst prepared in Example 2 has similar or better activity and stability than the curve for the catalyst prepared in Example 1 and could be used in commercial poly-ethylbenzene transalkylation operations.

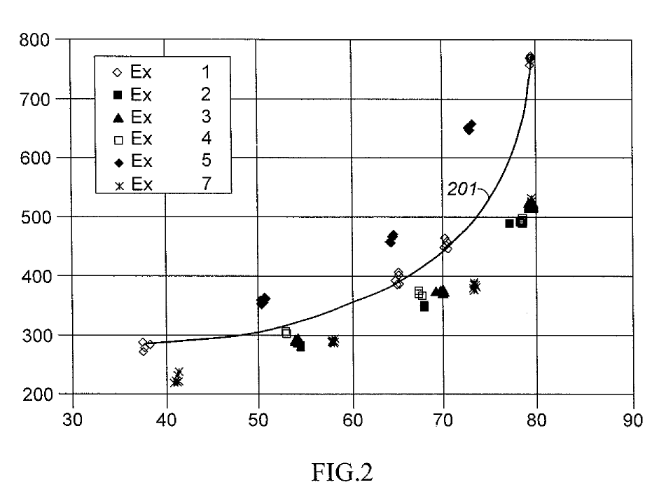

A summary of the data is provided by FIGS. 1-5 In FIG. 1, the DIPB conversion for Examples 2-4 and 7 are substantially higher than that exhibited for Examples 1 and 5, with Example 1 being represented by the line 101. In FIG. 2, the NPB/cumene ratio is lower for Examples 2-4 and 7 as compared to Example 1 which is represented by the line 201. In FIG. 3, the DIPB conversion is higher for the unegenexated catalyst of Example 7 and the regenerated catalyst of Example 9 in comparison to Example 1, which is represented by the line 101 from FIG. 1. In FIG. 4, the NPB/cumene ratio is lower for the unregenerated and regenerated catalyst of Examples 7 and 9 respectively as compared to Example 1, which is represented by a line 20l from FIG. 2 And, in FIG. 5, Example 2 exhibits superior DEB conversion over Example 1, which is represented by the line 501. It is believed that the lower activity and inferior product purity for the catalyst prepared in Comparative Example 5 are due to acid extraction conditions that were too severe. Thus, severe acid extraction conditions can reduce crystallinity of Y zeolite.

### LZ-210

Y zeolites which may be used in the process disclosed herein may be prepared by dealuminating a Y zeolite having an overall silica to alumina mole ratio below about 5 and are described in detail in U.S. Pat. Nos. 4,503,023, 4,597,956, 4,735,928 and 5,275,720 which are hereby incorporated herein by reference. The '023 patent discloses another procedure for dealuminating a Y zeolite involving contacting the Y zeolite with an aqueous solution of a fluorosilicate salt using controlled proportions, temperatures, and pH conditions which avoid aluminum extraction without silicon substitution. The '023 patent discloses that the fluorosilicate salt is used as the aluminum extractant and also as the source of extraneous silicon which is inserted into the Y zeolite structure in place of the extracted aluminum. The salts have the general formula:

(A)_{2/b} SiF₆

wherein A is a metallic or nonmetallic cation other than H⁺ having the valence “b.” Cations represented by “A” are alkylammonium, NH₄⁺, Mg⁺⁺, Li⁺, Na⁺, K⁺, Ba⁺⁺, Cd⁺⁺, Cu⁺⁺, H⁺, Ca⁺⁺, Cs⁺, Fe⁺⁺, Co⁺⁺, Pb⁺⁺, Mn⁺⁺, Rb⁺, Ag⁺, Sr⁺⁺, Ti⁺, and Zn⁺⁺.

A preferred member of this group of Y zeolites is known as LZ-210, a zeolitic aluminosilicate molecular sieve described in the '023 patent. LZ-210 zeolites and the other zeolites of this group are conveniently prepared from a Y zeolite starting material. In one embodiment, the LZ-210 zeolite has an overall silica to alumina mole ratio from about 5. 0 to about 11.0. The unit cell size ranges from about 24.38 to about 24.50 angstrom, preferably from about 24.40 to about 24.44 angstrom. The LZ-210 class of zeolites used in the process and composition disclosed herein have a composition expressed in terms of mole ratios of oxides as in the following formula:

(0.85−1.1)M_{2/n}O:Al₂O₃:xSiO₂

wherein “M” is a cation having the valence “n” and “x” has a value from 5.0 to 11.0.

In general, LZ-210 zeolites may be prepared by dealuminating Y-type zeolites using an aqueous solution of a fluorosilicate salt, preferably a solution of ammonium hexafluorosilicate. The dealumination can be accomplished by placing a Y zeolite, normally but not necessarily an ammonium exchanged Y zeolite, into an aqueous reaction medium such as an aqueous solution of ammonium acetate, and slowly adding an aqueous solution of ammonium fluorosilicate. After the reaction is allowed to proceed, a zeolite having an increased overall silica to alumina mole ratio is produced. The magnitude of the increase is dependent at least in part on the amount of fluorosilicate solution contacted with the zeolite and on the reaction time allowed. Normally, a reaction time of between about 10 and about 24 hours is sufficient for equilibrium to be achieved. The resulting solid product, which can be separated from the aqueous reaction medium by conventional filtration techniques, is a form of LZ-210 zeolite In some cases this product may be subjected to a steam calcination by methods well known in the art. For instance, the product may be contacted with water vapor at a partial pressure of at least 1.4 kpa(a) (0.2 psi(a)) for a period of between about ¼ to about 3 hours at a temperature between about 482° C. (˜900° F.) and about 816° C. (˜1500° F.) in order to provide greater crystalline stability. In some cases the product of the steam calcination may be subjected to an ammonium-exchange by methods well known in the art. For instance, the product may be slurried with water after which an ammonium salt is added to the slurry The resulting mixture is typically heated for a period of hours, filtered, and washed with water. Methods of steaming and ammonium-exchanging LZ-210 zeolite are described in U.S. Pat. Nos. 4,503,023, 4,735,928, and 5,275,720

In one embodiment, the ammonium exchange is followed by the treatment with an aqueous solution of a fluorosilicate salt to increase Si/Al₂ ratio, enhancing the hydrothermal stability and lowering the propensity to form extra-framework aluminum.

The final low pH, ammonium ion exchange of the LZ-210 zeolite, which is preferred, can be carried out in the same manner as in the case of the initial ammonium exchange of the Y zeolite (and/or LZ-210 zeolite as discussed above) except that the pH of the exchange medium is lowered to below about 4, preferably to below about 3, at least during some portion of the ion-exchange procedure. The lowering of the pH is readily accomplished by the addition of an appropriate mineral or organic acid to the ammonium ion solution. Nitric acid is especially suitable for this purpose. Preferably, acids which form insoluble aluminum salts are avoided. In performing the low ph ammonium ion exchange, both the pH of the exchange medium, the quantity of exchange medium relative to the zeolite and the time of contact of the zeolite with the exchange medium are significant factors It is found that so long as the exchange medium is at a pH below 4, sodium cations are exchanged for hydrogen cations in the zeolite and, in addition, at least some aluminum, predominately non-framework and some framework, is extracted. The efficiency of the process is improved, however, by acidifying the ion exchange medium using more acid than is required to lower the pH to just below 4. As will be evident from the data set forth below, the mote acidic the exchange medium is, the greater the tendency to extract framework as well as non-framework aluminum from the zeolite. The extraction procedure is carried out to a degree sufficient to produce a zeolite product having a bulk Si/Al₂ molar ratio ranging from about 6.5 to about 27. In other embodiments, the bulk Si/Al₂ molar ratio ranges from about 6.5 to about 23 or more preferably from about 6 5 to about 20.

The following LZ-210 examples are presented for purposes of illustration only and are not intended to limit the scope of this disclosure

### EXAMPLE 11

### Comparative

A sample of Y-74 zeolite was slurried in a 15 wt % NH₄NO₃ aqueous solution and the solution temperature was brought up to 75° C. (167° F.) Y-74 zeolite is a stabilized sodium Y zeolite with a bulk Si/Al₂ ratio of approximately 5.2, a unit cell size of approximately 24.53, and a sodium content of approximately 2.7 wt % calculated as Na₂O on a dry basis Y-74 zeolite is prepared from a sodium Y zeolite with a bulk Si/Al₂ ratio of approximately 4.9, a unit cell size of approximately 24.67, and a sodium content of approximately 9.4 wt % calculated as Na₂O on a dry basis that is ammonium exchanged to remove approximately 75% of the Na and then steam de-aluminated at approximately 600° C. (1112° F.) by generally following steps (1) and (2) of the procedure described in col. 4, line 47 to col. 5, line 2 of U.S. Pat. No. 5,324,877. Y-74 zeolite is produced and was obtained from UOP LLC, Des Plaines, Ill. USA After 1 hour of contact at 75° C. (167° F.), the slurry was filtered and the filter cake was washed with an excessive amount of warm de-ionized water These NH₄⁺ ion exchange, filtering, and water wash steps were repeated two mote times, and the resulting filter cake had a bulk Si/Al₂ ratio of 5.2, a sodium content of 0.13 wt % calculated as Na₂O on a dry basis, a unit cell size of the 24.572 Å and an absolute intensity of 96 as determined X-ray diffraction. The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1 59 mm ( 1/16 in) diameter cylindrical extrudate. The extrudate was dried and calcined at approximately 600° C. (1112° F.) for one hour in flowing air. This catalyst was representative of the existing art. This catalyst had a unit cell size of 24.494 Å, an XSD absolute intensity of 61.1, and 57.2 % framework aluminum as a percentage of the aluminum in the modified Y zeolite.

### EXAMPLE 12

As synthesized Y-54 zeolite was ammonium exchanged and then treated with ammonium fluorosilicate according to the procedure described in U.S. Pat. No. 4,503,023. Y-54 zeolite is a sodium Y zeolite with a bulk Si/Al₂ ratio of approximately 4.9, a unit cell size of 24.67, and a sodium content of 9.4 wt % calculated as Na₂O on a dry basis. Y-54 zeolite is produced and was obtained from UOP LLC, Des Plaines, Ill. USA. The resulting Y zeolite, which had a bulk Si/Al₂ molar ratio of about 6.5, was steamed at about 600° C. (111220 F.) with 100% steam for 1 hour, and then ammonium exchanged. The resulting filter cake was dried to an appropriate moisture level, mixed with HNO₃-peptized Pural SB alumina to give a mixture of 80 parts by weight of zeolite and 20 parts by weight Al₂O₃ binder on a dry basis, and then extruded into 1 59 mm ( 1/16 in) diameter cylindrical extrudate. The extrudate was dried and calcined at approximately 600° C. (1112° F.) for one hour in flowing air The resulting catalyst had a unit cell size of 24.426 Å, an absolute XRD intensity of 81.6, and 63.2% framework aluminum as a percentage of the aluminum in the modified Y zeolite

### EXAMPLE 13

As synthesized Y-54 zeolite was ammonium exchanged and then treated with ammonium fluorosilicate according to the procedure described in U.S. Pat. No. 4,503,023. The resulting Y zeolite, which had a bulk Si/Al₂ molar ratio of about 9.0 and was referred to as LZ-210(9), was steamed at about 600° C. (1112° F.) with 100% steam for 1 hour. A slurry made up of 228 g of the steamed LZ-210(9) and 672 g of H₂O was first prepared. A NH₄NO₃ solution made up of 212 g of H₂O and 667 g of 50 wt % (NH₄)NO₃ was then added to the steamed LZ-210(9) slurry. The resulting mixture was then raised to 85° C. (185° F.) and then mixed for 15 minutes To this mixture, 5.7 g of 66 wt % HNO₃ were added, and the resulting mixture was maintained at 85° C. (185° F.) with continuous agitation for 60 minutes. At the end of acid extraction, the mixture was filtered and the cake was washed with 1000 ml of H₂O, and then dried at 100° C. (212° F.) overnight. In the second part, 200 g of dry cake was added to a solution made up of 66.7 g of 50 wt % (NH₄)NO₃ and 650 g of H₂O, to which 20 g of 66 wt % HNO3 was added. The resulting sluriy was mixed for 60 minutes Thereafter, the mixture was filtered, washed with 1000 ml of H₂O and the filter cake was oven dried at 100° C. (212° F.) overnight. The resulting zeolite had a 10.82 bulk Si/Al₂ ratio and 0.026 wt % Na₂O The zeolite powder was mixed with HNO₃-peptized Pural SB alumina to give a mixture of 80 parts by weight of zeolite and 20 parts by weight Al₂O₃ binder on a dry basis, moisture adjusted to give proper dough texture and then extruded into 1 59 mm ( 1/16 in) diameter cylindrical extrudate The extrudate was dried and calcined at approximately 600° C. (1112° F.) for one hour in flowing air. The resulting catalyst had a unit cell size of 24.430 Å, an absolute XRD intensity of 78.4, 77.8% framework aluminum and a BET surface artea of 661 m²/g.

### EXAMPLE 14

As synthesized Y-54 zeolite was ammonium exchanged and then treated with ammonium fluorosilicate according to the procedure described in U.S. Pat. No. 4,503,023. The resulting Y zeolite, which had a bulk Si/Al₂ molar ratio of about 9.0 and was referred to as LZ-210(9), was steamed at about 600° C. (1112° F.) with 100% steam for 1 hour. An amount of 256 g of the steamed LZ-210(9) was added to 1140 g of 22 wt % NH₄NO₃. To the zeolite slurry, 368 g of 17 wt % HNO₃ was slowly added over a period of 30 minutes The slurry was then heated up to 80° C. (176° F.) and held at 80° C. (176° F.) for 90 minutes. At the end of acid extraction, the slurry was quenched with 1246 g of H₂O, filtered, washed with 1140 g of a 22 wt % NH₄NO₃, washed with 1000 ml of H₂O and oven dried at 100° C. (212° F.) overnight. The resulting zeolite had a bulk 14.38 Si/Al₂ ratio and 0.047 wt % Na₂O. The resulting zeolite powder was mixed with HNO₃-peptized Pural SB alumina to give a mixture of 80 parts by weight of zeolite and 20 parts by weight Al₂O₃ binder on a dry basis, moisture adjusted to give proper dough texture and then extruded into 1.59 mm ( 1/16 in) diameter cylindrical extrudate. The extrudate was dried and calcined at approximately 600° C. (1112° F.) for one hour in flowing air. The resulting catalyst had a unit cell size of 24.393 Å, an absolute XRD intensity of 79.6, 81.8% framework aluminum, and a BET surface area of 749 m²/g.

### EXAMPLE 15

As synthesized Y-54 zeolite was ammonium exchanged and then treated with ammonium fluorosilicate according to the procedure described in U.S. Pat. No. 4,503,023. The resulting Y zeolite, which had a bulk Si/Al₂ molar ratio of about 12 and was referred to as LZ-210(12), was steamed at about 600° C. (1112° F.) with 100% steam for 1 hour. A slurry made up of 231 g of the steamed LZ-210(12) and 668 g of H₂O was first prepared A NH₄NO₃ solution made up of 212 g of H₂O and 667 g of 50 wt % (NH₄)NO₃ was then added to the steamed LZ-210(12) slurry. The resulting mixture was then raised to 85° C. (185° F.) and then mixed for 15 minutes. To this mixture, 33.4 g of 66 wt % HNO₃ were added, and the resulting mixture was maintained at 85° C. (185° F.) with continuous agitation for 60 minutes. At the end of acid extraction, the mixture was filtered and the cake was washed with 1000 ml of H₂O, and then dried at 100° C. (212° F.) overnight. In the second part, 200 g of dry cake was added to a solution made up of 667 g of 50% (NH₄)NO₃ and 650 g of H₂O, to which 10 g of 66 wt % HNO₃ were added. The resulting slurry was mixed for 60 minutes Thereafter, the mixture was filtered, washed with 1000 ml of H₂O and the filter cake was oven dried at 100° C. (212° F.) overnight. The resulting zeolite had a 17.24 bulk Si/Al₂ ratio and 0.01 wt % Na₂O The resulting zeolite powder was mixed with HNO₃-peptized Pural SB alumina to give a mixture of 80 parts by weight of zeolite and 20 parts by weight Al₂O₃ binder on a dry basis, moisture adjusted to give proper dough texture and then extruded into 1.59 mm ( 1/16 in) diameter cylindrical extrudate. The extrudate was dried and calcined at approximately 600° C. (1112° F.) for one hour in flowing air. The resulting catalyst had a unit cell size of 24.391 Å, an absolute XRD intensity of 81.2, 94.9% framework aluminum and a BET surface area of 677 m²/g

### EXAMPLE 16

An amount of 250 g of the LZ-210(12) from Example 15 (before steaming) was added to a NH₄NO₃ solution made up of 500 g of 50% NH₄NO₃ and 625 g of H₂O. The slurry was heated up to 95° C. (203° F.) and hold at temperature for 2 hours The slurry was then filtered and water washed. The cake was then NH₄NO₃ exchanged and water washed a second time following the same procedure. The filter cake was oven dried at 100° C. (212° F.) overnight. The resulting zeolite had a 12.62 bulk Si/Al₂ ratio and 0 05 wt % Na₂O. The dried zeolite was mixed with HNO₃-peptized Pural SB alumina to give a mixture of 80 parts by weight of zeolite and 20 parts by weight Al₂O₃ binder on a dry basis, moisture adjusted to give appropriate dough texture and then extruded into 1.59 mm ( 1/16 in) diameter cylindrical extrudate. The extrudate was dried and calcined at approximately 600° C. (1112° F.) for one hour in flowing air. The resulting catalyst had a unit cell size of 24.431 Å, an absolute XRD intensity of 77.3, 89.2% framework aluminum and a BET surface area of 660 m²/g

Table 2 summarizes the properties of the catalysts prepared in Examples 1-6

TABLE 2

| | Example | | | | | | |
|---|---|---|---|---|---|---|---|
| | 1 | 2 | 3 | 4 | 5 | 6 | 8 |
| | Type of Example | | | | | | |
| | Comparative | Example | Example | Example | Example | Example | Example |
| Figures w/ Run Data | 1–4 | None | None | 1–4 | 1–2 | 1–2 | 1–2 |
| Y zeolite bulk Si/Al₂ | 5.20 | 8.61 | 10.82 | 14.38 | 17.24 | 12.62 | 12.62 |
| ratio, molar | | | | | | | |
| Y zeolite unit cell | 24.494 | 24.426 | 24.430 | 24.393 | 24.391 | 24.431 | 24.439 |
| size, Å | | | | | | | |
| Catalyst XRD | 61.1 | 81.6 | 78.4 | 79.6 | 81.2 | 77.3 | 72.5 |
| absolute intensity | | | | | | | |
| Y zeolite XRD | 76.4 | 102 | 98 | 99.5 | 101.5 | 96.6 | 90.6 |
| absolute intensity | | | | | | | |
| Y zeolite framework | 57.2 | 63.2 | 77.8 | 81.8 | 94.9 | 89.2 | 92.6 |
| aluminum, atomic % | | | | | | | |
| of total aluminum | | | | | | | |
| Catalyst BET surface | — | — | 661 | 749 | 677 | 660 | 660 |
| area, m²/g | | | | | | | |

### EXAMPLE 17

The catalysts prepared in the Examples 11 and 14-16 were tested for transalkylation performance using a feed containing benzene and polyalkylated benzenes. The feed was prepared by blending polyalkylated benzenes obtained from a commercial transalkylation unit with benzene. The feed composition as measured by gas chromatography is summarized in Table 2 above. The test was done in a fixed bed reactor in a once-through mode under conditions of 3447 kPa(g) (500 psi(g)) reactor pressure, a molar ratio of aromatic ring groups per propyl group of 2.3, and a 0.8 hr⁻¹ DIPB WHSV over a range of reaction temperatures The reactor was allowed to achieve essentially steady-state conditions at each reaction temperature, and the product was sampled for analysis. Essentially no catalyst deactivation occurred during the test. Prior to introducing the feed, each catalyst was subjected to a drying procedure by contacting with a flowing nitrogen stream containing less than 10 wt-ppm water at 250° C. (482° F.) for 6 hours.

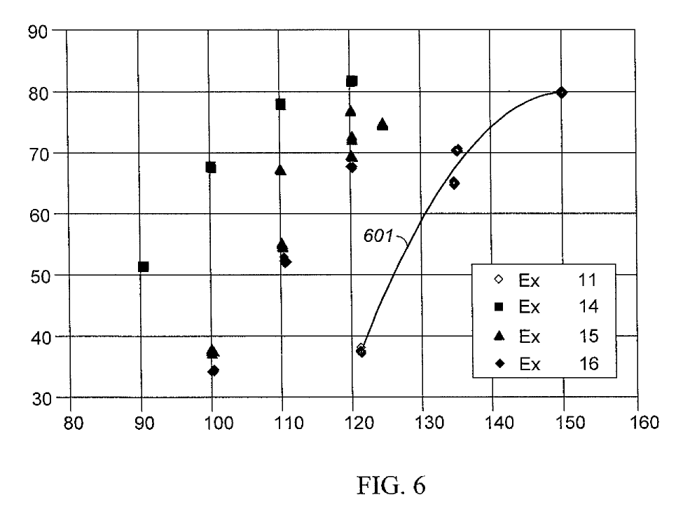

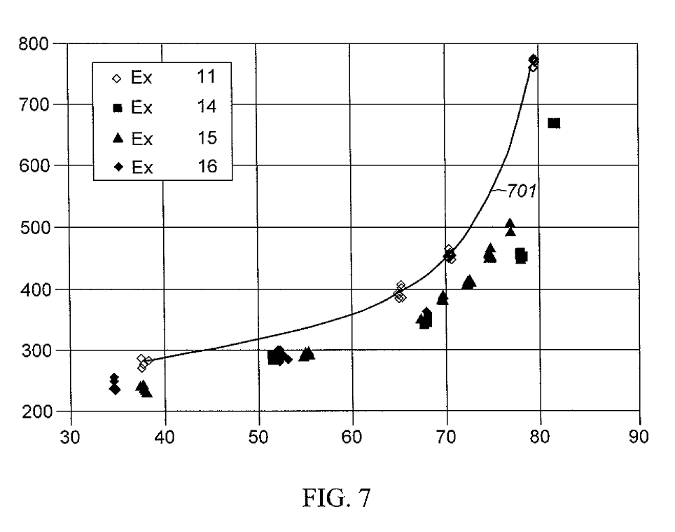

FIGS. 6 and 7 show the test results for the catalysts prepared in Examples 11 and 14-16. In FIG. 6, the catalysts prepared in Examples 14-16 show higher activities (i e., higher DIPB conversion at a given temperature) as compared to the curve 601 for Example 11. In FIG. 7, the catalysts prepared in Examples 14-16 also exhibit better product purities (i e., lower NPB/cumene at a given DIPB conversion) than the curve 701 for the catalyst prepared in Example 1. Referring to FIGS. 6 and 7, the data for Example 16 indicates that the steaming and acid extraction steps are not required in the catalyst preparation, since good performance can be achieved even when both are omitted. Still referring to FIGS. 6 and 7, the data for Example 14 indicates that superior activity and comparable product purity can be achieved using a single-step post-steaming acid extraction, instead of the two-step acid extraction of Example 15, despite the acid extraction conditions being more severe.

### EXAMPLE 18

A sample of the catalyst prepared in Example 16 was tested in the manner described in Example 17, as described previously. After testing, the spent catalyst was placed in a ceramic dish, which was placed in a muffle furnace. While flowing air was passed through the muffle furnace, the furnace temperature was raised from 70° C. (158° F.) to 550° C. (1022° F.) at a rate of 1° C. (1.8° F.) per minute, held at 550° C. (1022° F.) for 6 hours, and then cooled to 110° C. (230° F.). The regenerated catalyst had a unit cell size of 24.439 Å, an absolute XRD intensity of 72.5, 92.6% framework aluminum and a BET surface area of 660 m²/g. Table 3 summarizes the properties of the regenerated catalyst. Following regeneration, the catalyst was again tested in the manner described in Example 17. The catalysts before and after regeneration had similar activities (i.e., DIPB conversion at a given temperature) and product purities (i e., NPB/cumene at a given DIPB conversion) and therefore indicate good catalyst regenerability.

### EXAMPLE 19

A sample of the catalyst prepared in Example 14 was tested in the manner described in Example 17, as described previously. After testing, the spent catalyst was regenerated in the manner described in Example 18. Following regeneration, the catalyst was again tested in the manner described in Example 17.

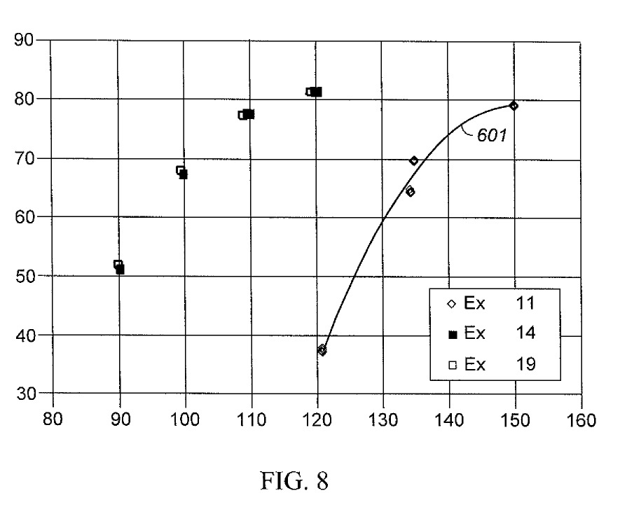

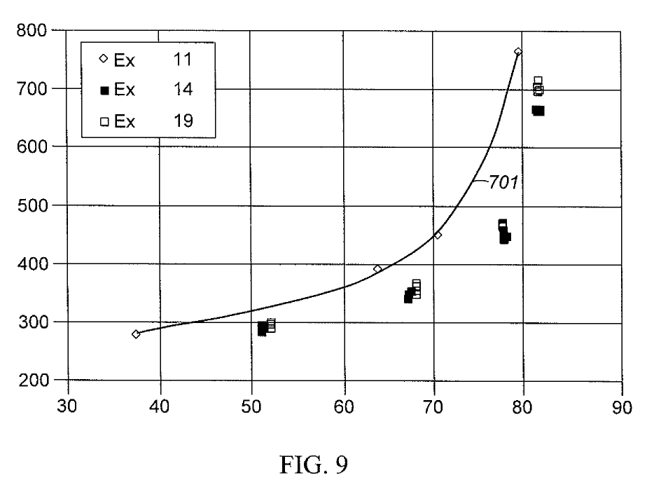

FIGS. 8 and 9 graphically illustrate the test results for the catalysts before regeneration (labeled “Example 14”) and after regeneration (labeled “Example 19”). The results indicate that the catalysts before and after regeneration had similar activities (i.e , DIPB conversion at a given temperature) and product purities (i e , NPB/cumene at a given DIPB conversion) that were both better than the curves 601, 701 of FIGS. 8, 9 respectively for the Example 11 catalyst, and therefore indicate good catalyst regenerability

The above examples show the benefits of high activity and product purity in transalkylating poly-alkylates such as DIPB and TIPB to cumene and and DEB to LB attributed to catalysts prepared by the process disclosed herein.

Although the disclosed catalyst may contain a metal hydrogenation catalytic component, such a component is not a requirement. Based on the weight of the catalyst, such a metal hydrogenation catalytic component may be present at a level of less than 0.2 wt % or less than 0.1 wt % calculated as the respective monoxide of the metal component, or the catalyst may be devoid of any metal hydrogenation catalytic component. If present, the metal hydrogenation catalytic component can exist within the final catalyst composite as a compound such as an oxide, sulfide, halide and the like, or in the elemental metallic state. As used herein, the term “metal hydrogenation catalytic component” is inclusive of these various compound forms of the metals The catalytically active metal can be contained within the inner adsorption region, i e., pore system, of the zeolite constituent, on the outer surface of the zeolite crystals or attached to or carried by a binder, diluent or other constituent, if such is employed. The metal can be imparted to the overall composition by any method which will result in the attainment of a highly dispersed state. Among the suitable methods are impregnation, adsorption, cation exchange, and intensive mixing. The metal can be copper, silver, gold, titanium, chromium, molybdenum, tungsten, rhenium, manganese, zinc, vanadium, or any of the elements in IUPAC Groups 8-10 especially platinum, palladium, rhodium, cobalt, and nickel. Mixtures of metals may be employed.

The finished catalyst compositions can contain the usual binder constituents in amounts which are in the range of from about 10 to about 95 wt %, preferably from about 15 to 50 wt %. The binder is ordinarily an inorganic oxide or mixtures thereof. Both amorphous and crystalline can be employed. Examples of suitable binders are silica, alumina, silica-alumina, clays, zirconia, silica-zirconia and silica-boria. Alumina is a preferred binder material.

For cumene production, the finished catalyst, made of 80 wt % zeolite and 20 wt % alumina binder on a volatile-free basis, preferably has one, and more preferably both, of the following physical characteristics: (1) an absolute intensity of the modified Y zeolite as measured by X-ray diffraction (XRD) of preferably at least 50, more preferably at least 60; and (2) a framework aluminum of the modified Y zeolite of preferably at least 60%, more preferably at least 70%, of the aluminum of the modified Y zeolite. In one example, the finished catalyst for cumene production has a product of the absolute intensity of the modified Y zeolite as measured by XRD and the % framework aluminum of the aluminum in the modified Y zeolite that is greater than 4200. For ethylbenzene production, the finished catalyst preferably has one, and more preferably both, of the following characteristics: (1) an absolute intensity of the modified Y zeolite as measured by X-ray diffraction (XRD) of prefer ably at least 65, more preferably at least 75; and (2) a framework aluminum of the modified Y zeolite of preferably at least 50%, more preferably at least 60%, of the aluminum of the modified Y zeolite. In one example, the finished catalyst for cumene production has a product of the absolute intensity of the modified Y zeolite as measured by XRD and the % framework aluminum of the aluminum in the modified Y zeolite that is greater than 4500.

As referred to herein, the absolute intensity by X-ray powder diffraction (XRD) of a Y zeolite material was measured by computing the normalized sum of the intensities of a few selected XRD peaks of the Y zeolite material and dividing that sum by the normalized sum of the intensities of a few XRD peaks of the alpha-alumina NBS 674a intensity standard, which is the primary standard and which is certified by the National Institute of Standards and Technology (NIST), an agency of the U.S. Department of Commerce The Y zeolite's absolute intensity is the quotient of the sums multiplied by 100:

$$Absolute Intensity = \frac{( Normalized Intensity of Y Zeolite Material Peaks ) \times 100}{( Normalized Intensity of Alpha \text{-} Alumina Standard Peaks )}$$

The scan parameters of the Y zeolite material and the alpha-alumina standard are shown in Table 3.

TABLE 3

| Material | Y zeolite | Alpha-alumina standard |
|---|---|---|
| 2T Ranges | 4–56 | 24.6–26.6, 34.2–36.2, 42.4–44.4 |
| Step Time | 1 sec/step or more | 1 sec/step |
| | depending on zeolite | |
| | content | |
| Step Width | 0.02 | 0.01 |
| Peaks | (511, 333), (440), (533), | (012), (104), (113) |
| | (642), (751, 555) + | |
| | (660, 822), (664) | |

For purposes of this disclosure, the absolute intensity of a Y zeolite that is mixed with a nonzeolitic binder to give a mixture of Z parts by weight of the Y zeolite and (100 −Z) parts by weight of the nonzeolitic binder on a dry basis can be computed from the absolute intensity of the mixture, using the formula, A=C (100/Z), where A is the absolute intensity of the Y zeolite and C is the absolute intensity of the mixture For example, where the Y zeolite is mixed with HNO₃-peptized Pural SB alumina to give a mixture of 80 parts by weight of zeolite and 20 parts by weight Al₂O₃ binder on a dry basis, and the measured absolute intensity of the mixture is 60, the absolute intensity of the Y zeolite is computed to be (60) (100/80) or 75.

As used herein, the unit cell size, which is sometimes referred to as the lattice parameter, means the unit cell size calculated using a method which used profile fitting to find the XRD peak positions of the (642), (822), (555), (840) and (664) peaks of faujasite and the silicon (111) peak to make the correction.

As used herein, the bulk Si/Al₂ mole ratio of a zeolite is the silica to alumina (SiO₂ to Al₂O₃) mole ratio as determined on the basis of the total or overall amount of aluminum and silicon (framework and non-framework) present in the zeolite, and is sometimes referred to herein as the overall silica to alumina (SiO₂ to Al₂O₃) mole ratio. The bulk Si/Al₂ mole ratio is obtained by conventional chemical analysis which includes all forms of aluminum and silicon normally present.

As used herein, the fraction of the aluminum of a zeolite that is framework aluminum is calculated based on bulk composition and the Kerr-Dempsey equation for framework aluminum from the article by G. T. Kerr, A. W. Chester, and D. H. Olson, Acta Phys Chem., 1978, 24, 169, and the article by G. T. Kerr, Zeolites, 1989, 9, 350

As used herein, dry basis means based on the weight after drying in flowing air at a temperature of about 900° C. (˜1652° F.) for about 1 hr

While only certain embodiments have been set forth, alternatives and modifications will be apparent from the above description to those skilled in the art. These and other alternatives are considered equivalents and within the spirit and scope of this disclosure and the appended claims.

1. A catalyst comprising a Y-85 or modified LZ-210 zeolite, the catalyst comprising:
from about 60 to about 90 wt% zeolite, the remainder alumina binder on a volatile-free basis;
the catalyst having an absolute intensity as measured by X-ray diffraction (XRD) of at least 50 and at least 60% of the aluminum of the zeolite being framework aluminum.

2. The catalyst of claim 1 wherein a product of the absolute intensity of the catalyst and the percentage of the aluminum of the zeolite that is framework aluminum taken as a whole number being greater than 4200.

3. The catalyst of claim 1 wherein the zeolite has a Na₂O content of less than 3 wt% based on the weight zeolite on a water-free basis.

4. The catalyst of claim 1 wherein the zeolite has a bulk Si/Al₂ molar ratio and ranging from about 6.5 to about 27.

5. The catalyst of claim 1 wherein the zeolite has a bulk Si/Al₂ molar ratio and ranging from about 6.5 to about 23

6. The catalyst of claim 1 wherein the zeolite has an absolute intensity of at least 60

7. The catalyst of claim 1 wherein the zeolite has an absolute intensity of at least 70.

8. The catalyst of claim 1 wherein at least 70% of the aluminum of the zeolite is framework aluminum.

9. The catalyst of claim 1 wherein the catalyst has a loss on ignition (LOI) at about 900° C. ranging from about 2 to about 4 wt%

10. The catalyst of claim 1 wherein the catalyst has a water content by Karl-Fischer titration of less than 4 wt%.

11. The catalyst of claim 1 wherein the zeolite is a Y-85 zeolite.

12. The catalyst of claim 1 wherein the zeolite is a modified LZ-210 zeolite.

13. The catalyst of claim 1 wherein the zeolite has a unit cell size of 24.58 Å or less.

14. The catalyst of claim 1 wherein the zeolite has a unit cell size ranging horn about 24.34 to about 24.58 Å.

15. A catalyst comprising a Y-85 zeolite, the catalyst comprising:
from about 70 to about 90 wt% Y-85 zeolite, the remainder alumina binder on a volatile-free basis;
the catalyst having an absolute intensity as measured by X-ray diffraction (XRD) of at least 50 at least 60 % of the aluminum of the Y-85 zeolite being framework aluminum, the catalyst having a unit cell size of 24.58 Å or less and a bulk Si/Al₂ molar ratio ranging from about 6.5 to about 27.

16. The catalyst of claim 15 wherein the Y-85 zeolite has a bulk Si/Al₂ molar ratio and ranging from about 6.5 to about 23.

17. The catalyst of claim 15 wherein the Y-85 zeolite as a unit cell size ranging from about 24.34 to about 24.58 Å.

18. A catalyst comprising a modified LZ-210 zeolite, the catalyst comprising:
from about 70 to about 90 wt% modified LZ-210 zeolite, the remainder alumina binder on a volatile-free basis;
the catalyst having an absolute intensity as measured by X-ray diffraction (XRD) of at least 50 at least 60 % of the aluminum of modified LZ-210 zeolite being framework aluminum, the catalyst having a unit cell size of 24.58 Å or less and a bulk Si/Al₂ molar ratio ranging from about 6.5 to about 27.

19. The catalyst of claim 18 wherein the modified LZ-210 zeolite has a bulk Si/Al₂ molar ratio and ranging from about 6.5 to about 23

20. The catalyst of claim 18 wherein the modified LZ-210 zeolite as a unit cell size ranging from about 24.34 to about 24.58 Å.
